(19) United States
(12) Patent Application Publication
(10) Pub. No.: US 2023/0061268 A1
(43) Pub. Date: Mar. 2, 2023

(54) DISTRIBUTED MACHINE LEARNING USING SHARED CONFIDENCE VALUES

(71) Applicant: International Business Machines Corporation, Armonk, NY (US)

(72) Inventors: Paul Schardt, Rochester, MN (US); Chad Albertson, Rochester, MN (US); Rachel Mertz, Rochester, MN (US); Laura J. Mokrzycki, Zumbrota, MN (US)

(73) Assignee: International Business Machines Corporation, Armonk, NY (US)

(21) Appl. No.: 17/404,060

(22) Filed: Aug. 17, 2021

(51) Int. Cl. G06N 20/00; G06F 16/28

(52) U.S. Cl. CPC G06N 20/00; G06F 16/285

(57) ABSTRACT

An embodiment includes generating, by a first edge computing device having a sensor, a dataset based on sensor data from the sensor. The embodiment generates, by an analytics engine hosted by the first edge computing device, a classification dataset comprising a classification for the dataset and a confidence value associated with the classification. The embodiment calculates a confidence difference between the confidence value and a reference confidence value received with a reference classification from a second edge computing device. The embodiment compares the confidence difference to a difference threshold value and generates, in a case in which the confidence difference is greater than the difference threshold value, a replacement dataset as an output replacement for the classification dataset, where the replacement dataset comprises the reference classification and an indication that the confidence value is less than the reference confidence value.

### BACKGROUND

The present invention relates generally to a method, system, and computer program product for cognitive sensor data analysis. More particularly, the present invention relates to a method, system, and computer program product for distributed machine learning using shared confidence values.

An Artificial Neural Network (ANN)— also referred to simply as a neural network—is a computing system made up of a number of simple, highly interconnected processing elements (nodes), which process information by their dynamic state response to external inputs. ANNs are processing devices (algorithms and/or hardware) that are loosely modeled after the neuronal structure of the mammalian cerebral cortex but on much smaller scales. A large ANN might have hundreds or thousands of processor units, whereas a mammalian brain has billions of neurons with a corresponding increase in magnitude of their overall interaction and emergent behavior.

A Deep Learning Neural Network, referred to herein as a Deep Neural Network (DNN) is an artificial neural network (ANN) with multiple hidden layers of units between the input and output layers. Similar to shallow ANNs, DNNs can model complex non-linear relationships. DNN architectures, e.g., for object detection and parsing, generate compositional models where the object is expressed as a layered composition of image primitives. The extra layers enable composition of features from lower layers, giving the potential of modeling complex data with fewer units than a similarly performing shallow network. DNNs are typically designed as feedforward networks.

### SUMMARY

The illustrative embodiments provide for distributed machine learning using shared confidence values. An embodiment includes generating, by a first edge computing device having a sensor, a first dataset based on sensor data from the sensor. The embodiment also includes generating, by an analytics engine hosted by the first edge computing device, a first classification dataset comprising a first classification for the first dataset and a first confidence value associated with the first classification. The embodiment also includes calculating a confidence difference between the first confidence value and a reference confidence value received with a reference classification from a second edge computing device. The embodiment also includes comparing the confidence difference to a difference threshold value. The embodiment also includes generating, in a case in which the comparing determines that the confidence difference is greater than the difference threshold value, a replacement dataset as an output replacement for the first classification dataset, where the replacement dataset comprises the reference classification and an indication that the first confidence value is less than the reference confidence value. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a cloud computing environment according to an embodiment of the present invention;

FIG. 2 depicts abstraction model layers according to an embodiment of the present invention;

FIG. 3 depicts a block diagram of an example edge computing environment in accordance with an illustrative embodiment;

FIG. 4 depicts a block diagram of an example edge computing environment that shows high level block diagrams of exemplary edge devices and an edge server in accordance with an illustrative embodiment;

FIG. 5 depicts a block diagram of an example edge network in accordance with an illustrative embodiment;

FIG. 6 depicts a block diagram of an example edge network in accordance with an illustrative embodiment;

FIG. 7 depicts a block diagram of an example CI data packet in accordance with an illustrative embodiment;

FIG. 8 depicts a block diagram of an example edge computing environment that shows a high level block diagram of an exemplary CIS module in accordance with an illustrative embodiment; and

FIG. 9 depicts a flowchart of an example process for sharing confidence values in accordance with an illustrative embodiment.

### DETAILED DESCRIPTION

Recent years have seen a rapid increase in the amount of sensor data being generated by Internet of Things (IoT) technologies and other edge computing devices. This has led to a strong interest in adapting Artificial Intelligence (AI) technologies to perform closer to the network edge where the data is generated. Local AI analytics has the potential to provide data inferences closer to real-time as it allows for more immediate processing of the data as it is generated. This is due, in part, to the elimination of network latency that otherwise occurs when the data must be transferred to a cloud server or datacenter for cognitive analysis.

However, in order to benefit from the elimination of network latency, research has been conducted to find ways to adapt cognitive processes to be as fast on edge devices as they are when performed by cloud or datacenter servers having more hardware resources. For example, a growing area of research involves various techniques known as model compression. The goal of model compression is to simplify a large, complex model to produce a lightweight counterpart model that is suitable for deployment in edge devices.

Examples of compression techniques include pruning, quantization, low-rank approximation and sparsity, knowledge distillation, and neural architecture search (NAS). Ideally, the simplified model will achieve the same level of accuracy as the original model. Many of these techniques have shown significant improvement in performance, making it feasible for deployment on edge devices. However, the performance improvements typically involve a tradeoff that results in a reduction in accuracy. Such accuracy reductions are commonly in a range of 2% to 5%, but may in some cases be more than a 20% reduction in accuracy.

The illustrative embodiments recognize that presently available solutions do not address or provide adequate solutions for this reduction in accuracy. The illustrative embodiments used to describe the invention generally address and solve the above-described problems and other problems related to the accuracy of compressed machine-learning models.

While neural networks are becoming more ubiquitous, each operates independently, making its own decisions based on its gathered sensor data. However, the illustrative embodiments recognize that it should be expected that two well-trained neural networks, despite being systems from the same or different vendors, should come to the same conclusion or confidence interval (CI). These confidence intervals are used to make decisions for the systems connected to the neural network. For example, in some embodiments, two neural network nodes are observing the same relative area, making their own decisions from onboard sensors, and generating their own CIs about what they are detecting. These two neural network share their data and CI with each other for a range of benefits.

Thus, disclosed embodiments allow for machine-learning nodes on a sensor-based edge network to share data and confidence intervals with other machine-learning nodes on the same or different sensor-based edge networks. This ability enhances the machine-learning node's decisions based on its detected data by having another machine-learning node, possibly with different sensors or training algorithms, reinforce its conclusions or provide additional information.

In an illustrative embodiment, an edge network includes one or more edge servers and a plurality of edge devices that each include a confidence interval sharing (CIS) module. In some embodiments, one or more of the edge devices communicates directly with the edge servers or through other network devices, such as a switch or router. Alternatively, the edge devices communicate directly with other edge devices.

In an illustrative embodiment, the edge devices are machine-learning nodes. The edge devices each host a respective local AI analytics engine that uses a trained machine-learning model, for example for object identification or classification. In some embodiments, an edge device generates datasets based on sensor data from an onboard sensor, e.g., where the sensor data may be image data from an image sensor, temperature data from a temperature sensor, audio data from a microphone, etc. The edge device then processes the sensor data to reach a conclusion as directed by an edge application. For example, the edge device determines a classification for datasets generated from the sensor data, and also generates confidence values associated with each of the classifications.

In some embodiments, an edge device is configured to share these classifications and confidence values with others edge devices. In some such embodiments, the edge device shares only classifications that are associated with confidence values that are within a prescribed confidence interval. For example, in some embodiments, the edge device may be configured by user settings or default settings set by a manufacturer. When the edge device processes a dataset, the output will typically include a collection of classifications and associated confidence values.

For example, the edge device may be configured for identifying types of animals or objects in captured images. In such embodiments, the processing of a dataset for a captured image will output a list of possible classifications (e.g., a list of animals or objects) and confidence values associated with each possible classification. In some embodiments, the edge device will share only the classification associated with the highest confidence value rather than the entire list. Embodiments in which the edge device shares only the classification data for the classification associated with the highest confidence value avoid excessive network traffic since other edge devices may have no need for classifications associated with low confidence values. In some embodiments, the edge device may predict that an image includes a particular animal or object with a low degree of confidence. In some embodiments, the edge device is configured to only share classification data when the confidence value is within a specified confidence interval, for example greater than a specified confidence interval (CI) threshold value. In various embodiments, the CI threshold value will be highly implementation-specific, and therefore may be any desired value. Also, in some embodiments, the CI threshold value is adjustable, for example by user settings. In some such embodiments, if the CI threshold value is greater than the highest confidence value, then the edge device will not share any classification data associated with these results. On the other hand, if the CI threshold value is less than the highest confidence value, then the edge device will share the classification associated with the highest confidence value.

In some embodiments, the edge device may request a classification and associated confidence value from one or more of the other edge devices. An edge device may request classification data from other edge devices for various reasons, for example to use as a reference point of comparison for one or more results of its own classification processing. In some embodiments, the edge device compares the highest confidence value to a confidence threshold value, and if the confidence value is less than the confidence threshold value, then the edge device will request classification data from one or more of the other edge devices that may have captured sensor data for the same object. In various embodiments, the confidence threshold value will be highly implementation-specific, and therefore may be any desired value. Also, in some embodiments, the confidence threshold value is adjustable, for example by user settings.

In some embodiments, if the confidence threshold value is greater than the highest confidence value, then the edge device will generate a request for classification data from one or more of the other edge devices. In some embodiments, the edge device may seek to use the confidence value generated by one or more other edge devices as a reference confidence value that serves as a point of comparison for the classification data generated by edge device. In some embodiments, the edge device transmits the request for the reference confidence value to one or more other edge devices directly. In some embodiments, the edge device transmits the request for the reference confidence value to one or more of the edge servers. In some such embodiments, the request transmitted to one or more of the edge servers includes an instruction executable by the edge server(s) to cause the edge server(s) to identify and provide the reference confidence values from one or more of the other edge devices.

In some embodiments, the edge device determines whether to use classification data generated by other edge devices based on metadata received with the classification data. In some embodiments, the metadata may include identifying information about the source edge device that generated the classification data and/or about software, firmware, and hardware on the source edge device. For example, the metadata may include information about the source edge device such as a node identifier, a network address, a manufacturer or vendor name or other identifier, a software identifier and/or version identifier, a firmware identifier and/or version identifier, and/or a hardware identifier and/or version identifier. In some such embodiments, the edge device parses the metadata received with the classification data and extracts information from the metadata. In some such embodiments the edge device compares one or more values extracted from the metadata with stored acceptance values. For example, the edge device may have stored acceptance values that include a list of one or more vendors and/or software versions. In this example, the edge device will compare the vendor and software version extracted from the metadata to its stored acceptance values in order to determine whether to use the classification data.

In some embodiments, if the edge device receives classification data that is acceptable, the edge device calculates a confidence difference between the confidence value generated by the edge device and the confidence value used as a reference confidence value that was generated by, and received from, another one of the edge devices. The confidence difference may be used by the edge device as an indication of how much more or less certain another edge device was about its classification conclusion. In some embodiments, the edge device then compares the confidence difference to a difference threshold value. In some such embodiments the edge device may use this comparison as a health check. In some such embodiments, if the confidence difference exceeds the difference threshold value, this may indicate that the edge device is malfunctioning or needs to be updated. In some such embodiments, the edge device generates, as an output replacement for the first classification dataset, a replacement dataset comprising the reference classification and an indication that the first confidence value is less than the reference confidence value. Thus, the difference threshold value will be highly implementation-specific, and therefore may be any desired value. Also, in some embodiments, the difference threshold value is adjustable, for example by user settings.

In some embodiments, the edge device may conversely receive a request for classification data, e.g., for the classification and associated confidence value for the highest confidence value. In some embodiments, the edge device may determine whether to provide this classification based on whether the highest confidence value is within a specified confidence interval as described above. In some embodiments, the edge device responds to the request by transmitting the requested classification data to the requesting edge device either directly or via an edge server.

In some embodiments, the edge device shares classification data if the highest confidence value is within the specified confidence interval without the need to receive a request. In some such embodiments, as the edge device generates classification data, the edge device evaluates each confidence value to determine if the confidence value is within the specified confidence interval. For classification data that meets this criteria, the edge device broadcasts the classification data towards other edge devices on the edge network. On the other hand, in some embodiments, the edge device does not broadcast classification data that includes confidence values that are not within the specified confidence interval.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. The steps described by the various illustrative embodiments can be adapted for providing explanations for decisions made by a machine-learning classifier model, for example.

Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, contrastive explanations, computer readable storage medium, high-level features, historical data, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

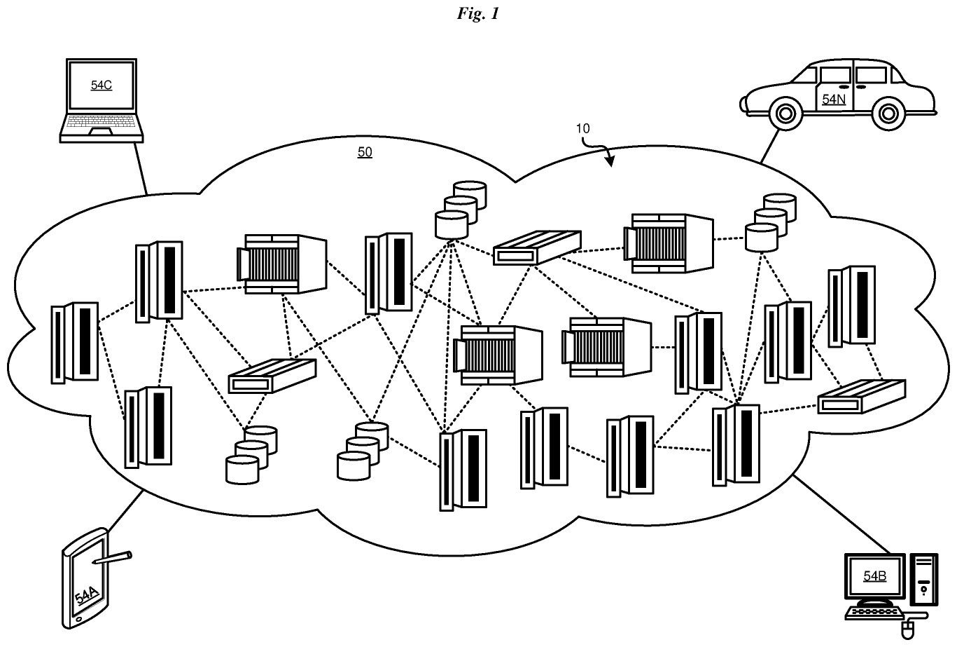

With reference to FIG. 1, this figure illustrates cloud computing environment 50. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

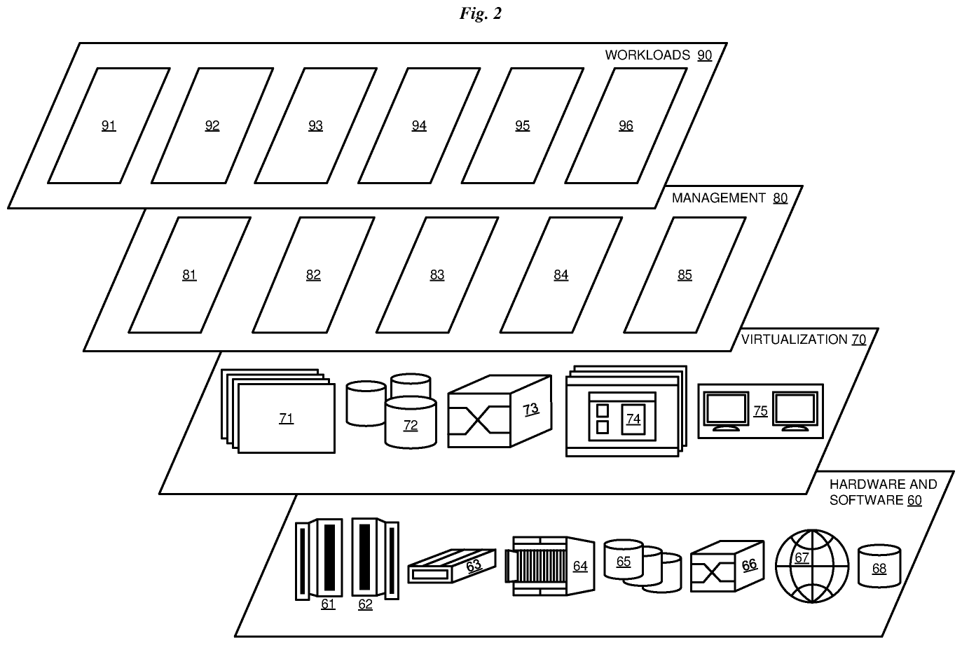

With reference to FIG. 2, this figure depicts a set of functional abstraction layers provided by cloud computing environment 50 (FIG. 1). It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and edge network management processing 96.

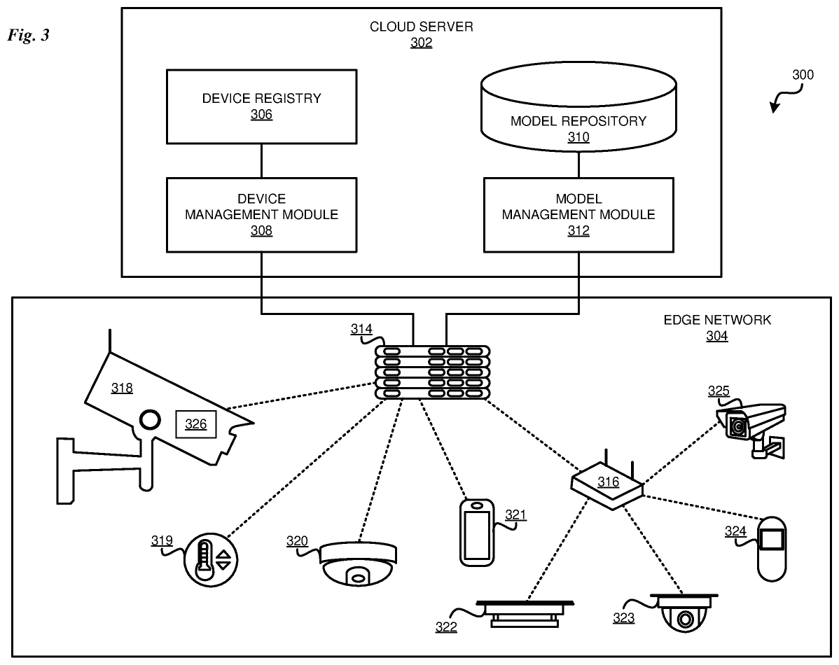

With reference to FIG. 3, this figure depicts a block diagram of an example edge computing environment 300 in accordance with an illustrative embodiment. In the illustrated embodiment, the edge computing environment 300 includes a cloud server 302 in communication with an edge network 304. In some embodiments, the cloud server 302 includes management modules 308, 312 that are deployed in workloads layer 90 of FIG. 2 providing edge network processing 96.

In the illustrated embodiment, the cloud server 302 includes a device registry 306, a device management module 308, a model repository 310, and a model management module 312. The device registry 306 stores information about devices that the edge system can read, communicate with, control, provision, or manage. The device management module 308 manages edge nodes and the service software lifecycle on edge nodes autonomously. The model repository 310 stores AI models for reference and further analysis. The model management module 312 supports storage, delivery, and security of models and other metadata packages.

In the illustrated embodiment, the edge network 304 includes one or more edge servers 314, a router 316, and a plurality of edge devices 318-325 that each include a confidence interval sharing (CIS) module 326. The edge servers 314 facilitate communications between the edge devices 318-325 and the cloud server 302. In some embodiments, the edge servers 314 also facilitate communications between the edge devices 318-325. In some embodiments, one or more of the edge devices 318-325 communicates directly with the edge servers 314 or through other network devices, such as the router 316. For example, in the illustrated embodiment, the edge devices 318-321 communicate directly with the edge servers 314, and edge devices 322-325 communicate with the edge servers 314 via the router 316.

In the illustrated embodiment, the edge devices 318-321 serve as non-limiting examples of machine-learning nodes. In the example embodiment, the edge devices include a box camera 318, temperature sensor 319, smoke detector 320, smart phone 321, smoke alarm 322, dome camera 323, motion sensor 324, and box camera 325. Actual implementations may include additional or fewer edge devices.

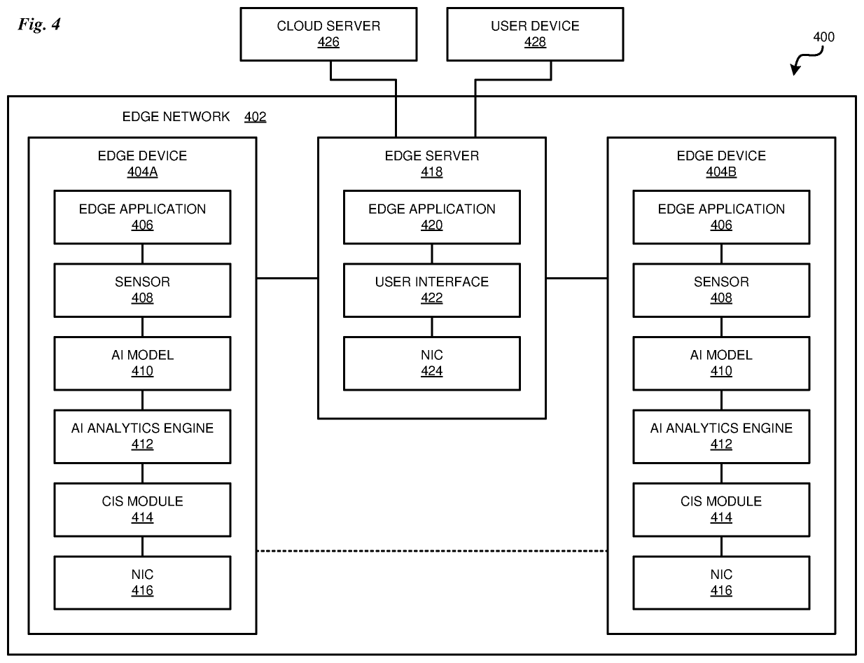

In the illustrated embodiment, edge devices 318-321 each host a respective local AI analytics engine (e.g., AI analytics engine 412 of FIG. 4) that has been trained, for example by model management module 312 in the cloud server 302. The local AI analytics engines may be manually deployed to the edge devices 318-321, for example, when the edge devices 318-321 are deployed into an application. In some examples, however, the edge devices 318-321 may request that an analytics engine be downloaded from the cloud server 302. In some embodiments, the AI analytics engines vary amongst the edge devices 318-321. For example, in some embodiments, some of the edge devices 318-321 and their respective AI analytics engines are identical, while others of the edge devices 318-321 have respective AI analytics engines that differ from each, for example by including software, firmware, and/or hardware from different vendors, and/or different software, firmware, and/or hardware versions.

Illustrative embodiments will be described using the edge device 318 as an example for the sake of simplicity with the understanding that the description applies equally to each of the edge devices 318-321. In some embodiments, the edge device 318 generates datasets based on sensor data from its sensor, e.g., where the sensor data may be image data from an image sensor of the edge device 318. The edge device 318 then determines a classification for the datasets and confidence values associated with each of the classifications.

In some embodiments, the edge device 318 is configured to share these classifications and confidence values with others edge devices 319-321. In some such embodiments the edge device 318 shares only classifications that are associated with confidence values that are within a prescribed confidence interval. For example, in some embodiments, the edge device 318 may be configured by user settings or default settings set by a manufacturer. When the edge device 318 processes a dataset, the output will typically include a collection of classifications and associated confidence values. For example, the edge device 318 may be configured for identifying types of animals in images may capture an image of a dog, and the processing of the dataset for this image will output a list of possible animals and confidence values associated with each possible animal. If the edge device 318 is able to identify that the image is an image of a dog with a high degree of confidence, the output may be a list of animals and associated confidence values in which the confidence value for dog is very high, and the confidence values for other animals is very low. A very simplified example of such an output is provided for explanatory purposes in Table 1 below:

TABLE 1

| | |
|---|---|
| DOG | 0.96 |
| CAT | 0.02 |
| COW | 0.00 |
| PIG | 0.01 |
| HORSE | 0.00 |
| RABBIT | 0.01 |
| BIRD | 0.00 |

In some embodiments, the edge device 318 will share only the classification DOG and its associated confidence value 0.96 rather than the entire list. Embodiments in which the edge device 318 shares only the classification data for the classification associated with the highest confidence value avoid excessive network traffic since other edge devices may have no need for classifications associated with low confidence values.

It is also possible that the edge device 318 may conclude that the image is an image of a dog, but arrive at this conclusion with a relatively low degree of confidence. A very simplified example of such an output is provided for explanatory purposes in Table 2 below:

TABLE 2

| | |
|---|---|
| DOG | 0.60 |
| CAT | 0.26 |
| COW | 0.00 |
| PIG | 0.12 |
| HORSE | 0.00 |
| RABBIT | 0.02 |
| BIRD | 0.00 |

In some embodiments, the edge device 318 is configured to only share classification data when the confidence value is within a specified confidence interval, for example greater than a specified confidence interval (CI) threshold value. In various embodiments, the CI threshold value will be highly implementation-specific, and therefore may be any desired value. Also, in some embodiments, the CI threshold value is adjustable, for example by user settings. In the example results shown in Table 2, if the CI threshold value is greater than 0.60, then the edge device 318 will not share any classification data associated with these results. On the other hand, if the CI threshold value is less than 0.60, then the edge device 318 will share the classification associated with the highest confidence value (DOG, 0.60).

In some embodiments, the edge device 318 may request a classification and associated confidence value from one or more of the other edge devices 319-321. An edge device may request classification data from other edge devices for various reasons, for example to use as a reference point of comparison for one or more results of its own classification processing. Using the results shown in Table 2 above as an example, the edge device 318 compares the confidence value (0.60) to a confidence threshold value, and if the confidence value is less than the confidence threshold value, then the edge device 318 will request classification data from one or more of the other edge devices 319-321 that may have captured sensor data for the same animal. In various embodiments, the confidence threshold value will be highly implementation-specific, and therefore may be any desired value. Also, in some embodiments, the confidence threshold value is adjustable, for example by user settings.

In the example shown in Table 2, if the confidence threshold value is greater than 0.60, then the edge device 318 will generate a request for classification data from one or more of the other edge devices 319-321 that may have captured sensor data of the same animal. In some embodiments, the edge device 318 may seek to use the confidence value generated by one or more other edge devices as a reference confidence value that serves as a point of comparison for the classification data generated by edge device 318. In some embodiments, the edge device 318 transmits the request for the reference confidence value to one or more other edge devices 319-321 directly. In some embodiments, the edge device 318 transmits the request for the reference confidence value to one or more of the edge servers 314. In some such embodiments, the request transmitted to one or more of the edge servers 314 includes an instruction executable by the edge server(s) 314 to cause the edge server(s) 314 to identify and provide the reference confidence values from one or more of the other edge devices 319-321.

In some embodiments, the edge device 318 receives a classification dataset that includes a classification and an associated confidence value generated by another of the edge devices 319-321 and used by the edge device 318 as a reference classification and an associated reference confidence value. The edge device 318 determines whether to use the reference classification and reference confidence value based on metadata received with the classification dataset. In some embodiments, the metadata may include identifying information about the source edge device that generated the classification dataset and/or about software, firmware, and hardware on the source edge device. For example, the metadata may include information about the source edge device such as a node identifier, a network address, a manufacturer or vendor name or other identifier, a software identifier and/or version identifier, a firmware identifier and/or version identifier, and/or a hardware identifier and/or version identifier. In some such embodiments, the edge device 318 parses the metadata received with the classification dataset and extracts information from the metadata. In some such embodiments the edge device 318 compares one or more values extracted from the metadata with stored acceptance values. For example, the edge device 318 may have stored acceptance values that include a list of one or more vendors and/or software versions. In this example, the edge device 318 will compare the vendor and software version extracted from the metadata to its stored acceptance values in order to determine whether to use the classification dataset.

In some embodiments, if the edge device 318 determines that the classification dataset is acceptable, the edge device 318 calculates a confidence difference between the confidence value generated by the edge device 318 and the reference confidence value. The confidence difference may be used by the edge device 318 as an indication of how much more or less certain another edge device was about its classification conclusion. In some embodiments, the edge device 318 then compares the confidence difference to a difference threshold value. In some such embodiments, if the confidence difference exceeds the difference threshold value, this may indicate that another of the edge devices 319-321 that generated the reference classification value and the reference confidence value had a better perspective of the subject of the classification processing. Thus, if the reference classification is different than the classification generated by the edge device 318, and the reference confidence value is much higher than the confidence value generated by the edge device 318, it will likely be more accurate for the edge device 318 to output the reference classification in place of the classification generated by the edge device 318. Thus, in some embodiments, the edge device 318 generates a replacement dataset as an output replacement for the classification dataset generated by the edge device 318 in which the output replacement comprises the reference classification along with, or in place of, the classification generated by the edge device 318. Also, in some embodiments, as a safeguard, the replacement output also includes an indication that the confidence value generated by the edge device 318 is less than the reference confidence value.

In some such embodiments the edge device 318 may use this comparison as a health check. In some such embodiments, if the confidence difference exceeds the difference threshold value, this may indicate that the edge device 318 is malfunctioning or needs to be updated. In some such embodiments, the edge device 318 generates, as an output replacement for the first classification dataset, a replacement dataset comprising the reference classification and an indication that the first confidence value is less than the reference confidence value. Thus, the difference threshold value will be highly implementation-specific, and therefore may be any desired value. Also, in some embodiments, the difference threshold value is adjustable, for example by user settings.

In some embodiments, the edge device 318 may conversely receive a request for classification data, e.g., for the classification and associated confidence value for the highest confidence value (e.g., DOG and 0.96 in the example shown in Table 1). In some embodiments, the edge device 318 may determine whether to provide this classification based on whether the highest confidence value is within a specified confidence interval as described above. In some embodiments, the edge device 318 responds to the request by transmitting the requested classification data to the requesting edge device either directly or via an edge server 314.

In some embodiments, the edge device 318 shares classification data if the highest confidence value is within the specified confidence interval without the need to receive a request. In some such embodiments, as the edge device 318 generates classification data, the edge device 318 evaluates each confidence value to determine if the confidence value is within the specified confidence interval. For classification data that meets this criteria, the edge device 318 broadcasts the classification data towards other edge devices 319-321 on the edge network 304. On the other hand, in some embodiments, the edge device 318 does not broadcast classification data that includes confidence values that are not within the specified confidence interval.

With reference to FIG. 4, this figure depicts a block diagram of an example edge computing environment 400 that shows high level block diagrams of exemplary edge devices 404A and 404B and edge server 418 in accordance with an illustrative embodiment. In a particular embodiment, edge devices 404A and 404B are examples of edge devices 318-321 of FIG. 3 and edge server 418 is an example of edge server 314 of FIG. 3.

In the illustrated embodiment, the edge server 418 on an edge network 402 is in communication with a plurality of edge devices, including edge devices 404A and 404B. The edge server 418 is also in communication with a cloud server 426 and a user device 428. Each of the edge devices 404A and 404B includes an edge application 406, a sensor 408, an AI model 410, an AI analytics engine 412, a CIS module 414, and a Network Interface Controller (NIC) 416. Also, the edge server 418 includes an edge application 420, a user interface 422, and a NIC 424. In some embodiments, the functionality described herein is distributed among a plurality of systems, which can include combinations of software and/or hardware based systems, for example Application-Specific Integrated Circuits (ASICs), computer programs, or smart phone applications.

In some embodiments, the edge applications 406 and 420 are applications, or components thereof, that utilize classification data generated by the edge devices 404A and 404B. The edge devices 404A and 404B each host a respective local AI analytics engines 412 that uses a trained AI model 410.

Illustrative embodiments will be described using the edge device 404A as an example for the sake of simplicity with the understanding that the description applies equally to each of the edge devices 404A and 404B. In some embodiments, the AI analytics engine 412 generates datasets based on sensor data from its sensor 408. The AI analytics engine 412 then determines a classification for the datasets and confidence values associated with each of the classifications.

In some embodiments, the CIS module 414 is an example of CIS module 326 of FIG. 3. The CIS module 414 is configured to share the classifications and confidence values from the AI analytics engine 412 with edge device 404B. In some such embodiments, the CIS module 414 shares only classifications that are associated with confidence values that are within a prescribed confidence interval. For example, in some embodiments, the CIS module 414 may be configured by user settings using the user interface 422 or default settings set by a manufacturer. When the AI analytics engine 412 processes a dataset, the output will typically include a collection of classifications and associated confidence values, such as those shown in Tables 1 and 2. With reference to the example shown in Table 1, the CIS module 414 will share only the classification DOG and its associated confidence value 0.96 rather than the entire list. Embodiments in which the CIS module 414 shares only the classification data for the classification associated with the highest confidence value avoid excessive network traffic since other edge devices may have no need for classifications associated with low confidence values.

In some embodiments, the CIS module 414 is configured to only share classification data when the confidence value is within a specified confidence interval, for example greater than a specified confidence interval (CI) threshold value. In various embodiments, the CI threshold value will be highly implementation-specific, and therefore may be any desired value. Also, in some embodiments, the CI threshold value is adjustable, for example by user settings set by a user via the user interface 422. In the example results shown in Table 2, if the CI threshold value is greater than 0.60, then the CIS module 414 will not share any classification data associated with these results. On the other hand, if the CI threshold value is less than 0.60, then the CIS module 414 will share the classification associated with the highest confidence value (DOG, 0.60).

In some embodiments, the CIS module 414 may request a classification and associated confidence value from the edge device 404B. An edge device may request classification data from other edge devices for various reasons, for example to use as a reference point of comparison for one or more results of its own classification processing. Using the results shown in Table 2 above as an example, the CIS module 414 compares the confidence value (0.60) to a confidence threshold value, and if the confidence value is less than the confidence threshold value, then the CIS module 414 will request classification data from edge device 404B. In various embodiments, the confidence threshold value will be highly implementation-specific, and therefore may be any desired value. Also, in some embodiments, the confidence threshold value is adjustable, for example by user settings set via the user interface 422.

In some embodiments, the CIS module 414 transmits the request for the reference confidence value via the NIC 416 to edge device 404B directly. In some embodiments, the edge device 404A transmits the request for the reference confidence value via the NIC 416 to edge server 418. In some such embodiments, the request transmitted to the edge server 418 is received by NIC 424. The request includes an instruction executable by the edge server 418 to cause the edge server 418 to identify and provide the reference confidence values from edge device 404B.

In some embodiments, the CIS module 414 determines whether to use classification data generated by other edge device 404B based on metadata received with the classification data. In some embodiments, the metadata may include identifying information about the source edge device that generated the classification data and/or about software, firmware, and hardware on the source edge device. For example, the metadata may include information about the source edge device such as a node identifier, a network address, a manufacturer or vendor name or other identifier, a software identifier and/or version identifier, a firmware identifier and/or version identifier, and/or a hardware identifier and/or version identifier. In some such embodiments, the CIS module 414 parses the metadata received with the classification data and extracts information from the metadata. In some such embodiments, the CIS module 414 compares one or more values extracted from the metadata with stored acceptance values. For example, the CIS module 414 may have stored acceptance values that include a list of one or more vendors and/or software versions. In this example, the CIS module 414 will compare the vendor and software version extracted from the metadata to its stored acceptance values in order to determine whether to use the classification data.

In some embodiments, if the CIS module 414 receives classification data that is acceptable, the CIS module 414 calculates a confidence difference between the confidence value generated by the AI analytics engine 412 and the confidence value used as a reference confidence value that was generated by, and received from, the edge device 404B. The confidence difference may be used by the CIS module 414 as an indication of how much more or less certain another edge device was about its classification conclusion. In some embodiments, the CIS module 414 then compares the confidence difference to a difference threshold value. In some such embodiments the edge device 404A may use this comparison as a health check. In some such embodiments, if the confidence difference exceeds the difference threshold value, this may indicate that the edge device 404A is malfunctioning or needs to be updated. In some such embodiments the edge device 404A generates, as an output replacement for the first classification dataset, a replacement dataset comprising the reference classification and an indication that the first confidence value is less than the reference confidence value. Thus, the difference threshold value will be highly implementation-specific, and therefore may be any desired value. Also, in some embodiments, the difference threshold value is adjustable, for example by user settings.

In some embodiments, the CIS module 414 may conversely receive a request for classification data, e.g., for the classification and associated confidence value for the highest confidence value (e.g., DOG and 0.96 in the example shown in Table 1). In some embodiments, the CIS module 414 may determine whether to provide this classification based on whether the highest confidence value is within a specified confidence interval as described above. In some embodiments, the CIS module 414 responds to the request by transmitting the requested classification data to the requesting edge device either directly or via edge server 418.

In some embodiments, the CIS module 414 shares classification data if the highest confidence value is within the specified confidence interval without the need to receive a request. In some such embodiments, as the AI analytics engine 412 generates classification data, the CIS module 414 evaluates each confidence value to determine if the confidence value is within the specified confidence interval. For classification data that meets this criteria, the CIS module 414 broadcasts the classification data towards other edge devices, including edge device 404B on the edge network 402. On the other hand, in some embodiments, the CIS module 414 does not broadcast classification data that includes confidence values that are not within the specified confidence interval.

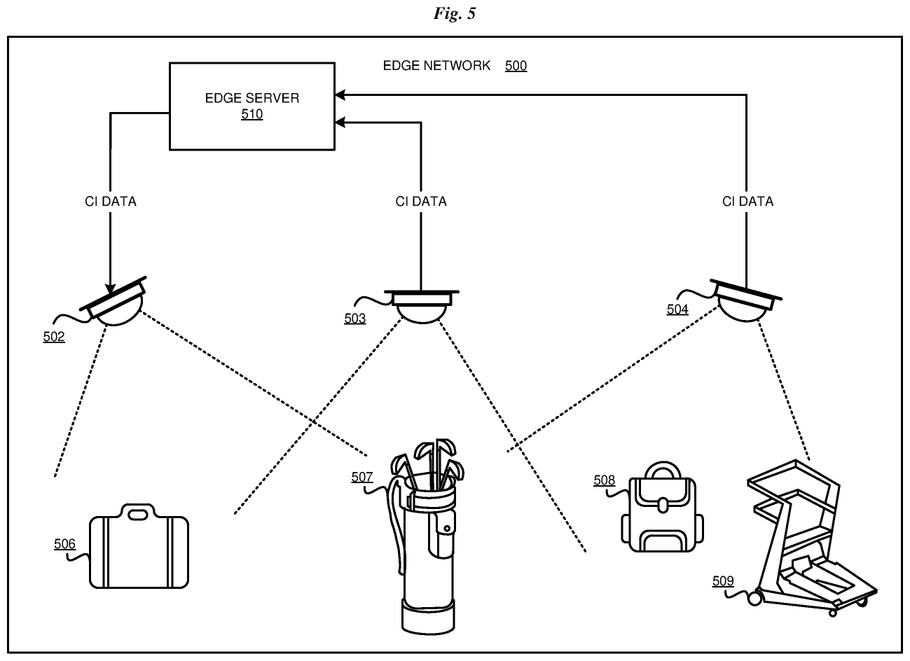

With reference to FIG. 5, this figure depicts a block diagram of an example edge network 500 in accordance with an illustrative embodiment. In the illustrated embodiment, the edge network includes edge devices 502-504 in communication with an edge server 510. In a particular embodiment, edge devices 502-504 are examples of edge devices 318-321 of FIG. 3 and edge server 510 is an example of edge server 314 of FIG. 3.

The illustrated embodiment is shown and described as an exemplary embodiment in which the edge devices 502-504 are dome cameras having image-capturing sensors. However, alternative embodiments include other types of edge devices have other types of sensors. The edge devices 502-504 each host a respective local AI analytics engine (e.g., AI analytics engine 412 of FIG. 4). In the illustrated embodiment, the edge devices 502-504 are configured for identifying various objects, such as suitcase 506, golf clubs 507, backpack 508, and luggage cart 509.

The edge devices 502-504 identify these and other types of objects in images captured by their respective image sensors. The edge devices 502-504 may be physically located close enough to each other to capture images of a same object at the same time, but at different angles and at different distances. As a result, the image quality will vary among the edge devices 502-504, as will the confidence values associated with the images. However, in the illustrated embodiment, the edge devices 502-504 are configured to share confidence values via the edge server 510. Thus, when one of the edge devices 502-504 is unable to get a clear image due to the distance, angle, or other factors of an object, it may use shared confidence values form the other edge devices 502-504 to help confirm a classification having a low confidence value.

For example, edge device 504 may classify object 506 as a suitcase with a low confidence value, while edge device 502 is able to classify object 506 as a suitcase with a high confidence value due to edge device 502 being much closer to object 506 than edge device 504. In the illustrated embodiment, the edge device 504 detects the low confidence value and, responsive to detecting the low confidence value, requests classification data via the edge server 510. The edge server 510 receives classification data from the edge device 502 having a high confidence value and provides this classification data to the edge device 504. The edge device 504 is then able to use this classification data from edge device 502 to confirm its classification result.

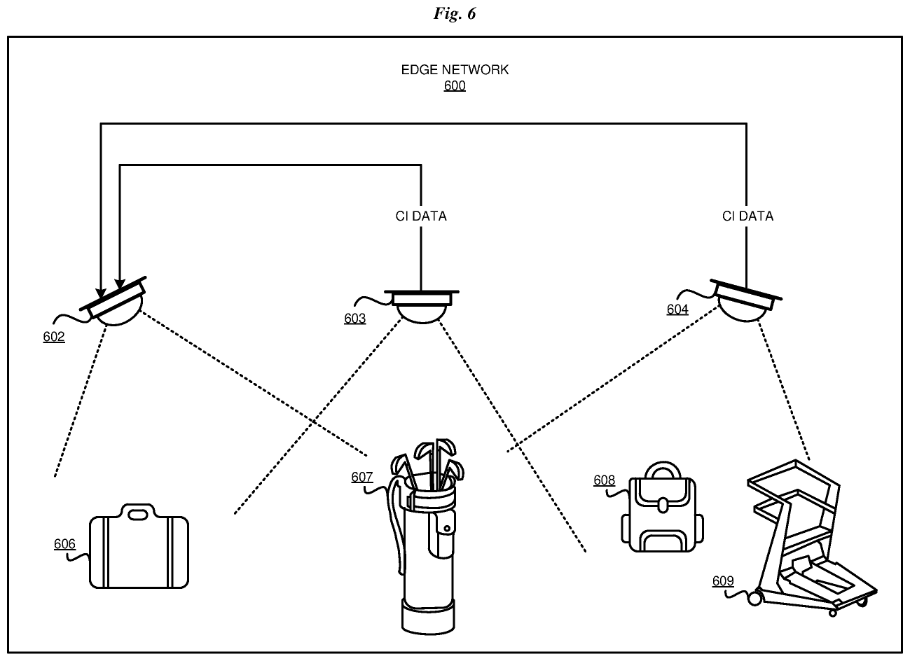

With reference to FIG. 6, this figure depicts a block diagram of an example edge network 600 in accordance with an illustrative embodiment. In the illustrated embodiment, the edge network includes edge devices 602-604 in communication with each other via the edge network 600. In a particular embodiment, edge devices 602-604 are examples of edge devices 318-321 of FIG. 3.

The illustrated embodiment is shown and described as an exemplary embodiment in which the edge devices 602-604 are dome cameras having image-capturing sensors. However, alternative embodiments include other types of edge devices having other types of sensors. The edge devices 602-604 each host a respective local AI analytics engine (e.g., AI analytics engine 412 of FIG. 4). In the illustrated embodiment, the edge devices 602-604 are configured for identifying various objects, such as suitcase 606, golf clubs 607, backpack 608, and luggage cart 609.

The edge devices 602-604 identify these and other types of objects in images captured by their respective image sensors. The edge devices 602-604 may be physically located close enough to each other to capture images of the same object at the same time, but at different angles and at different distances. As a result, the image quality will vary among the edge devices 602-604, as will the confidence values associated with the images. However, in the illustrated embodiment, the edge devices 602-604 are configured to share confidence values directly via the edge network 600. Thus, when one of the edge devices 602-604 is unable to get a clear image due to the distance, angle, or other factors of an object, it may use shared confidence values from the other edge devices 602-604 to help confirm a classification having a low confidence value.

For example, edge device 604 may classify object 606 as a suitcase with a low confidence value, while edge device 602 is able to classify object 606 as a suitcase with a high confidence value due to edge device 602 being much closer to object 606 than edge device 604. In the illustrated embodiment, the edge device 604 detects the low confidence value and, responsive to detecting the low confidence value, requests classification data via the edge network 600. The edge device 602 receives the request and responds by transmitting the classification data having a high confidence value to the edge device 604. The edge device 604 is then able to use this classification data from edge device 602 to confirm its classification result.

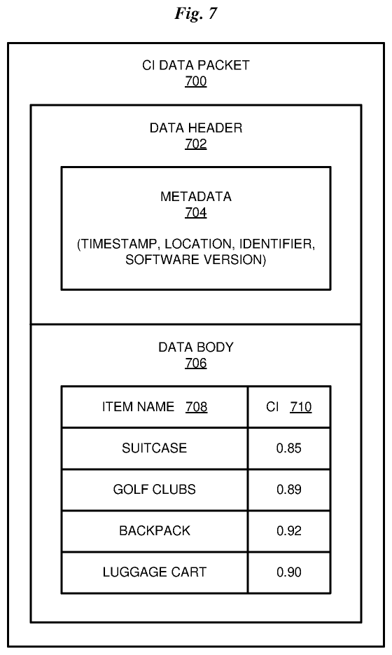

With reference to FIG. 7, this figure depicts a block diagram of an example CI data packet 700. In a particular embodiment, the CI data packet 700 is an example of classification data shared between edge devices, such as edge devices 602-604 of FIG. 6.

The illustrated embodiment is shown and described as an exemplary embodiment in which the CI data packet 700 is generated by an edge device configured for identifying various objects, such as the suitcase 606, golf clubs 607, backpack 608, and luggage cart 609 of FIG. 6. In the illustrated embodiment, the CI data packet 700 includes a data header 702 and a data body 706. The CI data packet 700 may be formatted according to any desired data model (e.g., comma-separated values (CSV), Extensible Markup Language (XML), JavaScript Object Notation (JSON), Yet Another Markup Language (YAML), etc.).

The data header 702 includes metadata 704. The metadata 704 may include various types of data. The types of data included in the metadata 704 will be highly implementation-specific, and therefore may be any desired types of data. In some embodiments, the metadata 704 includes one or more timestamps indicating times and dates for when the data was captured, location data indicating a location of the edge device transmitting the CI data packet 700 (e.g., GPS coordinates, floor of a building, room or corridor identifier, etc.), identifier data indicating an identity of the edge device transmitting the CI data packet 700 (e.g., node identifier, IP address, serial or inventory number, etc.), and/or software version data (e.g., software name, vendor name, software version, etc.).

The data body 706 includes one or more item names 708 and associated confidence interval (CI) data 710. The item names 708 include the classification result arrived at by the AI analytics engine of the transmitting edge device (e.g., suitcase, golf clubs, backpack, luggage cart).

The CI data 710 includes the confidence values associated with each of the items 708 (e.g., 0.85, 0.89, 0.92, 0.90). The CI data 710 in the illustrated embodiment includes values that are low precision floating point values ranging from 0 to 1, with 0 being very uncertain and 1 being very certain. In alternative embodiments, the CI data 710 includes values that are higher or lower precision and/or are based on alternative scales and/or alternative formats (e.g., 0 to 100, 0% to 100%, etc.). In some embodiments, the CI data 710 may be in a format other than a numerical format, such as alphanumeric characters or words indicating certainty (e.g., unknown, uncertain, fairly certain, extremely certain, etc.).

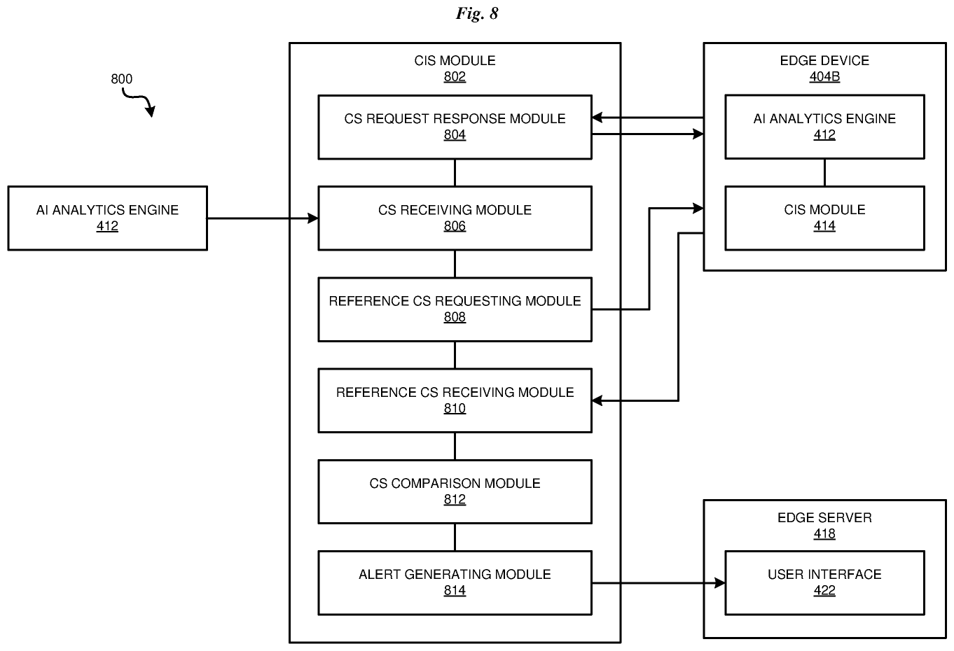

With reference to FIG. 8, this figure depicts a block diagram of an example edge computing environment 800 that shows a high level block diagram of an exemplary CIS module 802 in accordance with an illustrative embodiment. In a particular embodiment, CIS module 802 is an example of CIS module 414 of FIG. 4.

In the illustrated embodiment, the CIS module 802 includes confidence system (CS) request response module 804, CS receiving module 806, reference CS requesting module 808, reference CS receiving module 810, CS comparison module 812, and alert generating module 814. In some embodiments, the functionality described herein is distributed among a plurality of systems, which can include combinations of software and/or hardware based systems, for example Application-Specific Integrated Circuits (ASICs), computer programs, or smart phone applications. In the view shown in FIG. 8, elements having the same element number as elements of FIG. 4 generally identify the same or similar elements and/or components as those described with reference to FIG. 4 (i.e., AI analytics engine 412, CIS module 414, edge device 404B, edge server 418, and user interface 422).

In the illustrated embodiment, the CIS module 802 is configured to share the classifications and confidence values from the AI analytics engine 412 with edge device 404B. The CS receiving module 806 receives the classifications and confidence values from the AI analytics engine 412 and may provide functions such as buffering and filtering to prepare the data for other modules of the CIS module 802.

In some embodiments, the CIS module 802 shares only classifications that are associated with confidence values that are within a prescribed confidence interval. For example, in some embodiments, the CIS module 802 may be configured by user settings using the user interface 422 or default settings set by a manufacturer. When the AI analytics engine 412 processes a dataset, the output will typically include a collection of classifications and associated confidence values, such as those shown in Tables 1 and 2. With reference to the example shown in Table 1, the CIS module 802 will share only the classification DOG and its associated confidence value 0.96 rather than the entire list. Embodiments in which the CIS module 802 shares only the classification data for the classification associated with the highest confidence value avoid excessive network traffic since other edge devices may have no need for classifications associated with low confidence values.

In some embodiments, the CIS module 802 is configured to only share classification data when the confidence value is within a specified confidence interval. The CS comparison module 812 provides comparison functionality for determining if a confidence value is within the specified confidence interval, for example greater than a specified confidence interval (CI) threshold value. In various embodiments, the CI threshold value will be highly implementation-specific, and therefore may be any desired value. Also, in some embodiments, the CI threshold value is adjustable, for example by user settings set by a user via the user interface 422. In the example results shown in Table 2, if the CI threshold value is greater than 0.60, then the CS comparison module 812 will detect that none of the confidence values are greater than the specified CI threshold value, and will prevent the CIS module 802 from sharing any classification data associated with these results. On the other hand, if the CI threshold value is less than 0.60, then the CS comparison module 812 will allow the CIS module 802 to share the classification associated with the highest confidence value (DOG, 0.60).

In some embodiments, the reference CS requesting module 808 may request a classification and associated confidence value from the edge device 404B. An edge device may request classification data from other edge devices for various reasons, for example to use as a reference point of comparison for one or more results of its own classification processing. Using the results shown in Table 2 above as an example, the CS comparison module 812 compares the confidence value (0.60) to a confidence threshold value, and if the confidence value is less than the confidence threshold value, then the CS comparison module 812 signals the reference CS requesting module 808 to request classification data from edge device 404B. In various embodiments, the confidence threshold value will be highly implementation-specific, and therefore may be any desired value. Also, in some embodiments, the confidence threshold value is adjustable, for example by user settings set via the user interface 422.

In some embodiments, the reference CS requesting module 808 transmits the request for the reference confidence value to edge device 404B directly. In some embodiments, the reference CS requesting module 808 transmits the request for the reference confidence value to an edge server (e.g., edge server 418 of FIG. 4). In some such embodiments, the reference CS requesting module 808 prepares a request that includes an instruction executable by the edge server to cause the edge server to identify and provide the reference confidence values from edge device 404B.

In some embodiments, the reference CS receiving module 810 determines whether to use classification data generated by other edge device 404B based on metadata received with the classification data. In some embodiments, the metadata may include identifying information about the source edge device that generated the classification data and/or about software, firmware, and hardware on the source edge device. For example, the metadata may include information about the source edge device such as a node identifier, a network address, a manufacturer or vendor name or other identifier, a software identifier and/or version identifier, a firmware identifier and/or version identifier, and/or a hardware identifier and/or version identifier. In some such embodiments, the reference CS receiving module 810 parses the metadata received with the classification data and extracts information from the metadata. In some such embodiments, the reference CS receiving module 810 compares one or more values extracted from the metadata with stored acceptance values. For example, the reference CS receiving module 810 may have stored acceptance values that include a list of one or more vendors and/or software versions. In this example, the reference CS receiving module 810 will compare the vendor and software version extracted from the metadata to its stored acceptance values in order to determine whether to use the classification data.

In some embodiments, if the reference CS receiving module 810 receives classification data that is acceptable, the reference CS receiving module 810 provides the received data to the CS comparison module 812. The CS comparison module 812 calculates a confidence difference between the confidence value generated by the AI analytics engine 412 and the confidence value used as a reference confidence value that was generated by, and received from, the edge device 404B. The confidence difference may be used by the CIS module 802 as an indication of how much more or less certain another edge device was about its classification conclusion. In some embodiments, the reference CS receiving module 810 compares the confidence difference to a difference threshold value. In some such embodiments the CIS module 802, or edge device hosting the CIS module 802, may use this comparison as a health check. In some such embodiments, if the confidence difference exceeds the difference threshold value, this may indicate a malfunction or other issue requiring attention. In some such embodiments, the reference CS receiving module 810 notifies the alert generating module 814 of the issue. In response, the alert generating module 814 generates, as an output replacement for the first classification dataset, a replacement dataset comprising the reference classification and an indication that the first confidence value is less than the reference confidence value. For example, in the illustrated embodiment, the alert generating module 814 provides the replacement dataset to the user interface 422.

In some embodiments, the request response module 804 may receive a request for classification data, e.g., for the classification and associated confidence value for the highest confidence value (e.g., DOG and 0.96 in the example shown in Table 1). In some embodiments, the reference CS receiving module 810 may determine whether to provide this classification based on whether the highest confidence value is within a specified confidence interval as described above. In some embodiments, the request response module 804 responds to the request by transmitting the requested classification data to the requesting edge device either directly or via an edge server.

In some embodiments, the CIS module 802 shares classification data if the highest confidence value is within the specified confidence interval without the need to receive a request. In some such embodiments, as the AI analytics engine 412 generates classification data, the reference CS receiving module 810 evaluates each confidence value to determine if the confidence value is within the specified confidence interval. For classification data that meets this criteria, the CIS module 802 broadcasts the classification data towards other edge devices, including edge device 404B. On the other hand, in some embodiments, the CIS module 802 does not broadcast classification data that includes confidence values that are not within the specified confidence interval.

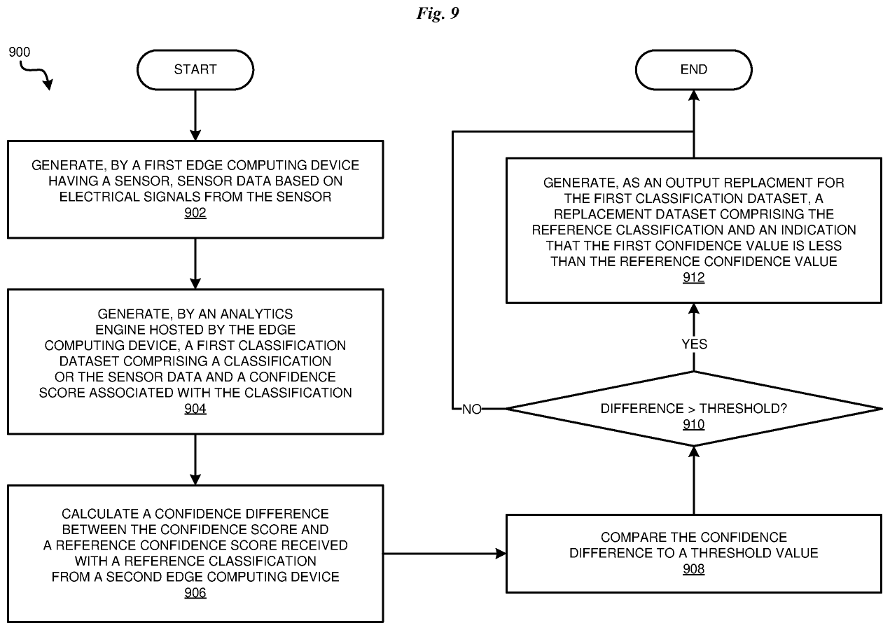

With reference to FIG. 9, this figure depicts a flowchart of an example process 900 for sharing confidence values in accordance with an illustrative embodiment. In a particular embodiment, the edge device 404A of FIG. 4 carries out the process 900.

In an embodiment, at block 902, the process generates, by a first edge computing device having a sensor, sensor data based on electrical signals from the sensor. Next, at block 904, the process determines, by an analytics engine hosted by the edge computing device, a classification for the sensor data and a confidence value associated with the classification. Next, at block 906, the process calculates a confidence difference between the confidence value and a reference confidence value received from a second edge computing device. Next, at block 908, the process compares the confidence difference to a threshold value. Next, at block 910, if the confidence difference is greater than the threshold value, the process continues to block 912; otherwise, the process bypasses block 912 and ends. At block 912, the process generates, as an output replacement for the first classification dataset, a replacement dataset comprising the reference classification and an indication that the first confidence value is less than the reference confidence value.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM) or Flash memory, a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
generating, by a first edge computing device having a sensor, a first dataset based on sensor data from the sensor;
generating, by an analytics engine hosted by the first edge computing device, a first classification dataset comprising a first classification for the first dataset and a first confidence value associated with the first classification;
calculating a confidence difference between the first confidence value and a reference confidence value received with a reference classification from a second edge computing device;
comparing the confidence difference to a difference threshold value; and
generating, in a case in which the comparing determines that the confidence difference is greater than the difference threshold value, a replacement dataset as an output replacement for the first classification dataset, wherein the replacement dataset comprises the reference classification and an indication that the first confidence value is less than the reference confidence value.

2. The method of claim 1, further comprising:
comparing the first confidence value to a confidence threshold value; and
generating a request for the reference confidence value if the first confidence value is less than the confidence threshold value.

3. The method of claim 2, further comprising:
transmitting the request for the reference confidence value to the second edge computing device.

4. The method of claim 2, further comprising:
transmitting the request for the reference confidence value to an edge server,
wherein the request includes an instruction executable by the edge server to cause the edge server to identify and provide the reference confidence value.

5. The method of claim 1, further comprising:
determining whether to use the reference confidence value based on metadata received with the reference confidence value.

6. The method of claim 5, wherein the determining of whether to use the reference confidence value comprises:
parsing the metadata received with the reference confidence value;
comparing a metadata value from the metadata to a stored acceptance value; and
accepting, responsive to determining that the metadata matches the stored acceptance value, the reference confidence value.

7. The method of claim 6, wherein the parsing of the metadata comprises extracting a software version from the metadata, and
wherein the comparing of the metadata value to the stored acceptance value comprises comparing the software version to the stored acceptance value, wherein the stored acceptance value comprises data indicative of a compatible software version.

8. The method of claim 6, wherein the parsing of the metadata comprises extracting a node identifier from the metadata, and
wherein the comparing of the metadata value to the stored acceptance value comprises comparing the node identifier to the stored acceptance value, wherein the stored acceptance value comprises data indicative of a reliable node identifier.

9. The method of claim 1, further comprising:
receiving a request for the first classification and the first confidence value from a third edge computing device; and
transmitting, responsive to the request, the first classification and the first confidence value to the third edge computing device if the confidence difference is greater than the difference threshold value.

10. The method of claim 1, further comprising:
generating, by the first edge computing device, a second dataset based on sensor data from the sensor;
determining, by the analytics engine, a second classification for the second dataset and a second confidence value associated with the second classification;
comparing the second confidence value to a confidence interval (CI) threshold value; and
broadcasting, responsive to determining that the second confidence value is greater than the CI threshold value, classification data associated with the second classification.

11. The method of claim 10, wherein the broadcasting comprises broadcasting the classification data to an edge server on an edge network with the first edge computing device.

12. The method of claim 10, wherein the broadcasting comprises broadcasting the classification data to the second edge computing device.

13. The method of claim 10, wherein the classification data comprises the second classification and the second confidence value.

14. The method of claim 1, further comprising:
generating, by the first edge computing device, a second dataset based on sensor data from the sensor;
generating, by the analytics engine, a second classification dataset comprising a second classification for the second dataset and a second confidence value associated with the second classification;
comparing the second confidence value to a confidence interval (CI) threshold value; and
broadcasting, responsive to determining that the second confidence value is greater than the CI threshold value, classification data associated with the second classification.

15. A computer program product comprising one or more computer readable storage media, and program instructions collectively stored on the one or more computer readable storage media, the program instructions executable by a processor to cause the processor to perform operations comprising:
generating, by a first edge computing device having a sensor, a first dataset based on sensor data from the sensor;
generating, by an analytics engine hosted by the first edge computing device, a first classification dataset comprising a first classification for the first dataset and a first confidence value associated with the first classification;
calculating a confidence difference between the first confidence value and a reference confidence value received with a reference classification from a second edge computing device;
comparing the confidence difference to a difference threshold value; and
generating, in a case in which the comparing determines that the confidence difference is greater than the difference threshold value, a replacement dataset as an output replacement for the first classification dataset, wherein the replacement dataset comprises the reference classification and an indication that the first confidence value is less than the reference confidence value.

16. The computer program product of claim 15, wherein the stored program instructions are stored in a computer readable storage device in a data processing system, and wherein the stored program instructions are transferred over a network from a remote data processing system.

17. The computer program product of claim 15, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

18. The computer program product of claim 15, further comprising:
generating, by the first edge computing device, a second dataset based on sensor data from the sensor;
generating, by the analytics engine, a second classification dataset comprising a second classification for the second dataset and a second confidence value associated with the second classification;
comparing the second confidence value to a confidence interval (CI) threshold value; and
broadcasting, responsive to determining that the second confidence value is greater than the CI threshold value, classification data associated with the second classification.

19. A computer system comprising a processor and one or more computer readable storage media, and program instructions collectively stored on the one or more computer readable storage media, the program instructions executable by the processor to cause the processor to perform operations comprising:
generating, by a first edge computing device having a sensor, a first dataset based on sensor data from the sensor;
generating, by an analytics engine hosted by the first edge computing device, a first classification dataset comprising a first classification for the first dataset and a first confidence value associated with the first classification;
calculating a confidence difference between the first confidence value and a reference confidence value received with a reference classification from a second edge computing device;
comparing the confidence difference to a difference threshold value; and
generating, in a case in which the comparing determines that the confidence difference is greater than the difference threshold value, a replacement dataset as an output replacement for the first classification dataset, wherein the replacement dataset comprises the reference classification and an indication that the first confidence value is less than the reference confidence value.

20. The computer system of claim 19, further comprising:
generating, by the first edge computing device, a second dataset based on sensor data from the sensor;
generating, by the analytics engine, a second classification dataset comprising a second classification for the second dataset and a second confidence value associated with the second classification;
comparing the second confidence value to a confidence interval (CI) threshold value; and
broadcasting, responsive to determining that the second confidence value is greater than the CI threshold value, classification data associated with the second classification.
